(19) United States
(12) Patent Application Publication
(10) Pub. No.: US 2015/0070497 A1
(43) Pub. Date: Mar. 12, 2015

(54) RECORDING APPARATUS FOR VEHICLES AND METHOD OF RECORDING

(71) Applicants: Justin J.Y. LIN, Taichung (TW); GRAND MATE CO., LTD., Taichung (TW)

(72) Inventor: Justin J.Y. LIN, Taichung (TW)

(73) Assignees: GRAND MATE CO., LTD., Taichung (TW); Justin J.Y. LIN, Taichung (TW)

(21) Appl. No.: 14/019,718

(22) Filed: Sep. 6, 2013

(51) Int. Cl. B60R 11/04; H04N 1/21

(52) U.S. Cl. CPC B60R 11/04; H04N 1/2129; B60R 2300/302
USPC 348/148

(57) ABSTRACT

A recoding apparatus for vehicles includes a camera module, a storage module, a trigger, a processor, and a wireless transmission module. The camera module captures images and converts the images into a first video file accordingly. The storage module is electrically connected to the camera module to save the first video file. The processor is electrically connected to the storage module and the trigger respectively to receive a start signal from the trigger, and to extract a second video file from the first video file, and then to save the second video file in the storage module. The wireless transmission module is electrically connected to the storage module and the processor to transmit the second video file to at least a remote storage device via wireless transmission, and the second video file is saved in the remote storage device.

### BACKGROUND OF THE INVENTION

1. Technical Field

The present invention relates to a vehicle, and more particularly to a recording apparatus for vehicles and a method of recording.

2. Description of Related Art

In present days, there are plenty of vehicles on the roads, and since the traffic is getting heavier, car accidents occur every day. In order to help clarify the attribution of responsibility in case of car accidents, more and more drivers have a driving recorder installed in their vehicles to record videos while driving.

A conventional driving recorder usually saves the video files into a memory card. However, the memory card has a limited capacity, and the capacity may be only sufficient for saving hours of videos, so that the old video files will be overwritten by new files after recording for a period of time. If the driver doesn't backup the memory card periodically, he/she will loss those videos recorded a couple of days ago.

Besides, the length of each video file is usually longer than 30 minutes. However, accidents happen in just a few seconds. Therefore, how to find the critical video segments in the memory card is not an easy job.

In conclusion, the conventional driving recorder still needs to be improved.

### BRIEF SUMMARY OF THE INVENTION

In view of the above, the primary objective of the present invention is to provide a recording apparatus for vehicles and a method of recording, which saves the critical video segments as a specific file, and outputs the file via wireless transmission immediately.

In order to achieve the objective of the present invention, a recording apparatus for vehicles includes a camera module, a storage module, a trigger, a processor, and a wireless transmission module. The camera module captures images and converts the images into a first video file accordingly. The storage module is electrically connected to the camera module to save the first video file. The trigger generates a start signal. The processor is electrically connected to the storage module and the trigger respectively to receive the start signal from the trigger, to extract a second video file from the first video file, and then to save the second video file into the storage module. The wireless transmission module is electrically connected to the storage module and the processor to transmit the second video file to at least a remote storage device through wireless transmission, and the second video file is saved in the remote storage device.

In an embodiment, the trigger has a button electrically connected to the processor to generate the start signal when the button is pressed.

In an embodiment, the trigger has an accelerometer electrically connected to the processor, and when the accelerometer detects an instantaneous acceleration larger than a predetermined acceleration value, the trigger generates the start signal.

In an embodiment, the processor generates an alarm and sends the alarm out through the wireless transmission module.

In an embodiment, the trigger has a touch screen electrically connected to the processor to generate the start signal while a predetermined icon on the touch screen is touched.

In an embodiment, the wireless transmission module transmits the second video file via Bluetooth, Wi-Fi, 3G, LTE, or WiMAX.

In an embodiment, the second video file is read-only.

In an embodiment, video content of the second video file starts from a predetermined time prior to a time point when the processor receives the start signal, to the time point when the processor receives the start signal.

In an embodiment, the recording apparatus for vehicles further includes a GPS module electrically connected to the processor to generate a location data, and the location data is transmitted to the remote storage device along with the second video file.

In an embodiment, the recording apparatus for vehicles further includes a timer electrically connected to the processor to generate a time data, and the time data is transmitted to the remote storage device along with the second video file.

The present invention further provides method of recoding and storing videos while driving, which includes the following steps:

A. Set connection data for communication with at least a remote storage device;

B. Capture images continuously, convert the images into a first video file, and then save the first video file;

C. Detect a start signal, and extract a second video file from the first video file if the start signal is detected, and then save the second video file; and

D. Automatically connect to the remote storage device according to the connection data, and then transmit the second video file to the remote storage device via wireless transmission, and save the second video file in the remote storage device.

In an embodiment, the start signal is generated by pressing a button.

In an embodiment, the start signal is generated by touching a predetermined icon on a touch screen.

In an embodiment, the start signal is generated if an instantaneous acceleration larger than a predetermined acceleration is detected.

In an embodiment, the method further includes the step of generating an alarm when the start signal is received.

In an embodiment, the second video file is transmitted via Bluetooth, Wi-Fi, 3G, LTE, or WiMAX.

In an embodiment, the second video file is read-only.

In an embodiment, video content of the second video file starts from a predetermined time prior to a time point when the processor receives the start signal to the time point when the processor receives the start signal.

In an embodiment, the connection data includes an IP address or a MAC address of the remote storage device.

In an embodiment, the second video file is sent to a plurality of the remote storage devices at the same time.

In an embodiment, the second video file is sent to a plurality of the remote storage devices in a predetermined order.

The present invention further provides a recording system for vehicles, including at least a remote storage device and a recording apparatus for vehicles. The remote storage device has a first storage module and a communication module electrically connected to the first storage module. The recording apparatus includes a camera module, a second storage module, a trigger, a processor, and a wireless transmission module. The camera module captures images and converts the images into a first video file accordingly. The second storage module is electrically connected to the camera module to save the first video file. The trigger generates a start signal. The processor is electrically connected to the second storage module and the trigger respectively to receive the start signal from the trigger, and to extract a second video file from the first video file, and then to save the second video file in the second storage module. The wireless transmission module is electrically connected to the second storage module and the processor. The wireless transmission module connects to the communication module of the remote storage device automatically to transmit the second video file to the remote storage device via the communication module, and the second video file is saved in the first storage module of the remote storage device.

Therefore, the driver may save the critical video segments in the remote storage device automatically.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of a first preferred embodiment of the present invention;

FIG. 2 is a block diagram of a second preferred embodiment of the present invention;

FIG. 3 is a block diagram of a third preferred embodiment of the present invention; and

FIG. 4 is a block diagram of a fourth preferred embodiment of the present invention.

### DETAILED DESCRIPTION OF THE INVENTION

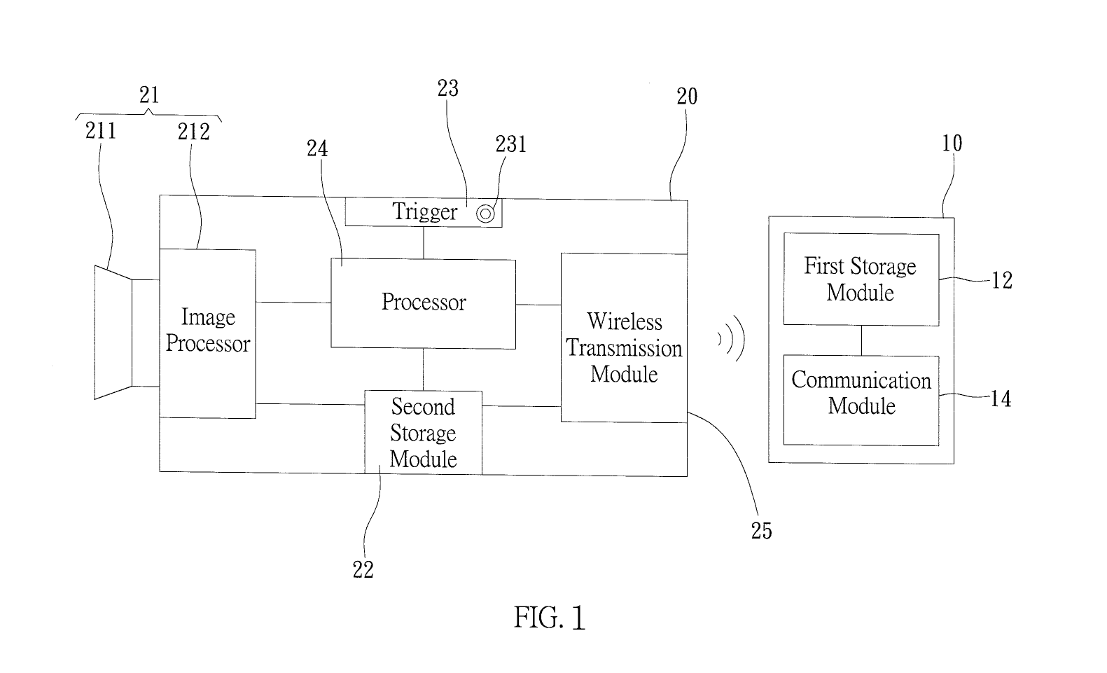

As shown in FIG. 1, a recording system for vehicles of the first preferred embodiment of the present invention includes a remote storage device 10 and a recording apparatus 20.

The remote storage device 10 includes a first storage module 12 and a communication module 14, which is electrically connected to the first storage module 12. In an embodiment, the remote storage device 10 is a server, the first storage module 12 is a hard disk drive of the server, and the communication module 14 is a network interface card.

The driving recorder 20 includes a camera module 21, a second storage module 22, a trigger 23, a processor 24, and a wireless transmission module 25.

The camera module 21 has a lens 211 and an image processor 212. The lens 211 captures images continuously to the image processor 212, and the image processor 212 converts the images into a first video file.

The second storage module 22 is electrically connected to the image processor 212 to receive and save the first video file. In an embodiment, the second storage module 22 is a memory card, and it may be a flash memory or a hard disk drive also.

The trigger 23 has a button 231 to generate a start signal when the button 231 is pressed.

The processor 24 is electrically connected to the image processor 212, the trigger 23, and the second storage module 22 respectively, and the processor 24 is able to turn the image processor 212 on or off. When the processor 24 receives the start signal from the trigger 23, the processor 24 extracts a second video file from the first video file, and video content of the second video file starts from a predetermined time prior to a time point when the processor 24 receives the start signal, to the time point when the processor 24 receives the start signal. The processor 24 then saves the second video file in the second storage module 22 as a read-only file. In an embodiment, the video content of the second video file starts from five minutes prior to the time point when the processor 24 receives the start signal. In practice, the predetermined time may be three minutes, one minute, 30 seconds, and so on.

The wireless transmission module 25 is electrically connected to the processor 24 and the second storage module 22 respectively. After the second video file being saved in the second storage module 22, the wireless transmission module 25 establishes a wireless communication with the communication module 14 of the remote storage device 10 automatically, and then transmits the second video file to the remote storage device 10 for being saved in the first storage module 12. In an embodiment, the wireless transmission module 25 transmits data via 3G telecommunications technology. In practice, data may be transmitted via Bluetooth, Wi-Fi, LTE, or WiMAX, and so on.

With the recording system, a method of recording while driving includes the following steps:

A. Set connection data for communication with the remote storage device 10.

In an embodiment, the connection data includes an IP address of the communication module 14 of the remote storage device 10. In practice, the connection data may include a MAC address of the communication module 14 as well as other information that could be used to establish connection.

B. Activate the camera module 21 to capture images continuously, convert the images into a first video file, and then save the first video file in the second storage module 22.

C. Detect a start signal.

If the start signal is received, extract a second video file from the first video file. The second video file has the video content starting from a predetermined time prior to a time point when the start signal is received, to the time point when the start signal is received.

In the present embodiment, the trigger 23 will generate the start signal when the button 231 is pressed, and the start signal is then transmitted to the processor 24.

D. Automatically establish connection between the wireless transmission module 25 and the communication module 14 of the remote storage device 10 according to the connection data provided in the step A, and then transmit the second video file to the remote storage device 10 via wireless transmission for saving it in the first storage module 12.

When a car accident occurs, the driver may press the button 231 to generate the second video file, and to transmit to the remote storage device 10. Since the video length of the video content of the second video file is only minutes or seconds, so that the file size is too small to cause heavy loading for the remote storage device 10. Because the second video file is read-only, it could avoid the file being deleted unexpectedly or altered by others. The police office may access the remote storage device 10 to obtain the second video file to find out what happened in the accident.

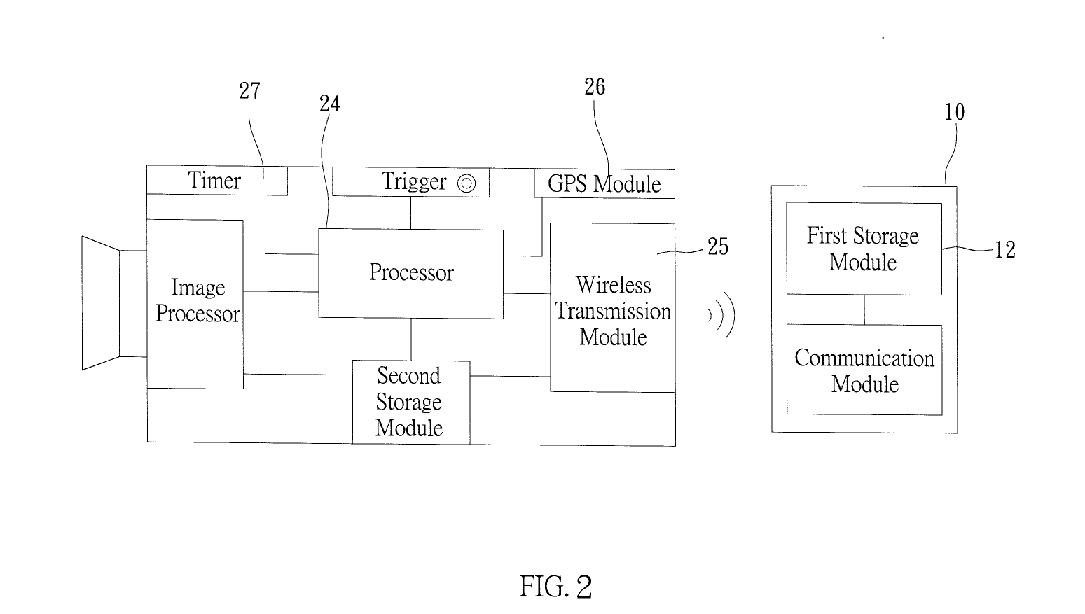

As shown in FIG. 2, a recording apparatus 20 further is provided with a GPS module 26 and a timer 27, both of which are electrically connected to the processor 24. In the step D, a location data and time data are sent to the remote storage device 10 along with the second video file, and are saved in the second storage module 12. That would provide the complete information of the car accident.

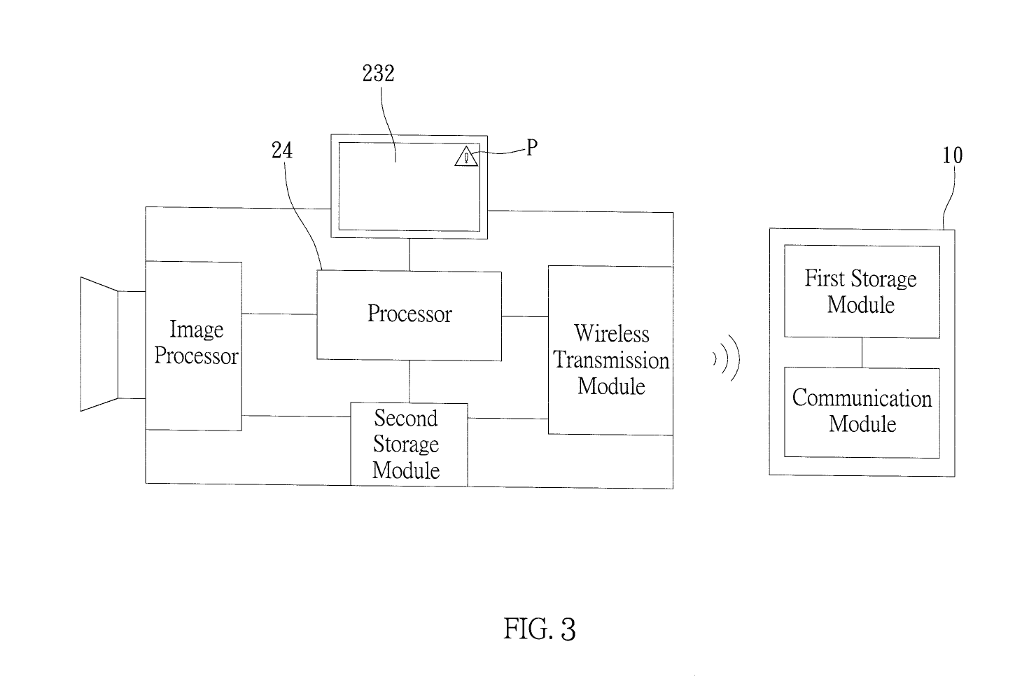

FIG. 3 shows the trigger 23 has a touch screen 232, on which a predetermined icon P is shown. While the driver touches the icon P on the touch screen 232, it will generate the start signal, and if the start signal is detected, the step C and the step D may be performed. In addition, the touch screen 232 may show information of the recording apparatus 20, such as battery status, memory capacity, and so on.

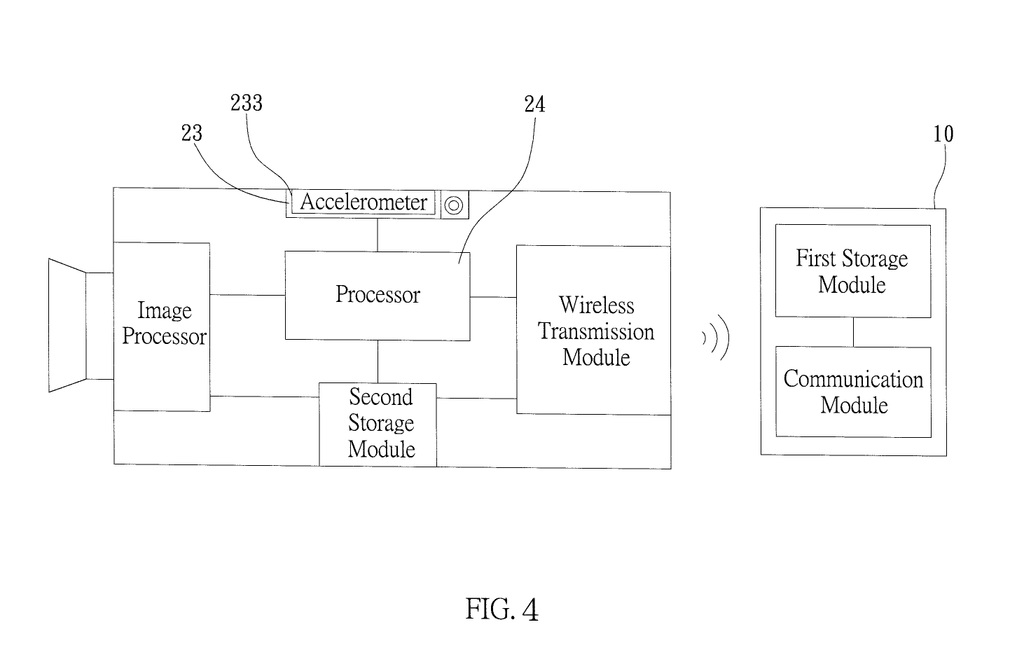

FIG. 4 shows the trigger 23 further having an accelerometer 233. If the accelerometer 233 detects an instantaneous acceleration larger than a predetermined acceleration value, which means the vehicle got an impact, the trigger 23 will generate a start signal and send it to the processor 24 that makes the recording apparatus send the second video file to the remote storage device 10 automatically. Besides the second video file, the recording apparatus may send an alarm to a specific receiver, such as the car rental company, the car owner, and so on, to inform related people that the car may get an accident.

There might be two or more remote storage devices 10 connected to the recording apparatus 20. The recording apparatus 20 may send the second video file to all of the remote storage devices 10 at the same time, or it may send the second video file to one of the remote storage devices 10 first, and if this remote storage device 10 does not respond, then send it to another remote storage device 10 until the second video file is correctly saved in one of the remote storage devices 10.

In additional to be used for car accidents, sometimes the driver may witness beneficence or bad manner happening on the road, and since the recording apparatus 20 might have recorded it, he/she may press the button to send the second video file to the remote storage device 10. A specific website may be connected to the remote storage device 10 for uploading the video files, and the website may provide these videos to public for social education purpose.

It is noted that besides the server, the remote storage device 10 may be a smart phone, a tablet, a computer, a PDA, a cloud device, or other devices with storage and transmission functions.

It must be pointed out that the embodiments described above are only some preferred embodiments of the present invention. All equivalent structures which employ the concepts disclosed in this specification and the appended claims should fall within the scope of the present invention.

What is claimed is:

1. A recording apparatus for vehicles, comprising:
a camera module for capturing images and converting the images into a first video file accordingly;
a storage module electrically connected to the camera module to save the first video file;
a trigger for generating a start signal;
a processor electrically connected to the storage module and the trigger respectively to receive the start signal from the trigger, and to extract a second video file from the first video file, and then to save the second video file into the storage module; and
a wireless transmission module electrically connected to the storage module and the processor to transmit the second video file to at least a remote storage device through wireless transmission, and the second video file is saved in the remote storage device.

2. The recording apparatus of claim 1, wherein the trigger has a button electrically connected to the processor to generate the start signal when the button is pressed.

3. The recording apparatus of claim 1, wherein the trigger has an accelerometer electrically connected to the processor, and when the accelerometer detects an instantaneous acceleration larger than a predetermined acceleration value, the trigger generates the start signal.

4. The recording apparatus of claim 3, wherein the processor generates an alarm and sends the alarm out through the wireless transmission module.

5. The recording apparatus of claim 1, wherein the trigger has a touch screen electrically connected to the processor to generate the start signal while a predetermined icon on the touch screen is touched.

6. The recording apparatus of claim 1, wherein the wireless transmission module transmits the second video file via Bluetooth, Wi-Fi, 3G, LTE, or WiMAX.

7. The recording apparatus of claim 1, wherein the second video file is read-only.

8. The recording apparatus of claim 1, wherein video content of the second video file starts from a predetermined time prior to a time point when the processor receives the start signal, to the time point when the processor receives the start signal.

9. The recording apparatus of claim 1, further comprising a GPS module electrically connected to the processor to generate a location data, and the location data is transmitted to the remote storage device along with the second video file.

10. The recording apparatus of claim 1, further comprising a timer electrically connected to the processor to generate a time data, and the time data is transmitted to the remote storage device along with the second video file.

11. A method of recoding and storing videos while driving, comprising the steps of:
A. setting connection data for communication with at least a remote storage device;
B. capturing images continuously, converting the images into a first video file, and then saving the first video file;
C. detecting a start signal, and extract a second video file from the first video file if the start signal is detected, and then save the second video file; and
D. automatically connecting to the remote storage device according to the connection data, and then transmitting the second video file to the remote storage device via wireless transmission, and saving the second video file in the remote storage device.

12. The method of claim 11, wherein the start signal is generated by pressing a button.

13. The method of claim 11, wherein the start signal is generated by touching a predetermined icon on a touch screen.

14. The method of claim 11, wherein the start signal is generated if an instantaneous acceleration larger than a predetermined acceleration is detected.

15. The method of claim 14, further comprising the step of generating an alarm when the start signal is detected.

16. The method of claim 11, wherein the second video file is transmitted via Bluetooth, Wi-Fi, 3G, LTE, or WiMAX.

17. The method of claim 11, wherein the second video file is read-only.

18. The method of claim 11, wherein video content of the second video file starts from a predetermined time prior to a time point when the processor receives the start signal, to the time point when the processor receives the start signal.

19. The method of claim 11, wherein the connection data includes an IP address or a MAC address of the remote storage device.

20. The method of claim 11, wherein the second video file is sent to a plurality of the remote storage devices at the same time.

21. The method of claim 11, wherein the second video file is sent to a plurality of the remote storage devices in a predetermined order.

22. The recording system for vehicles, comprising:
at least a remote storage device comprising a first storage module and a communication module electrically connected to the first storage module; and
a recording apparatus comprising a camera module for capturing images and converting the images into a first video file accordingly; a second storage module electrically connected to the camera module to save the first video file; a trigger for generating a start signal; a processor electrically connected to the second storage module and the trigger respectively to receive the start signal from the trigger, and to extract a second video file form the first video file, and then to save the second video file in the second storage module; and a wireless transmission module electrically connected to the second storage module and the processor, wherein the wireless transmission module connects to the communication module of the remote storage device automatically to transmit the second video file to the remote storage device via the communication module, and the second video file is saved in the first storage module of the remote storage device.
